(19) United States
(12) Patent Application Publication
(10) Pub. No.: US 2026/0171947 A1
(43) Pub. Date: Jun. 18, 2026

(54) SYSTEM AND METHOD FOR REDUCING INVERTER SWITCHING NOISE

(71) Applicants: Hyundai Motor Company, Seoul (KR); Kia Corporation, Seoul (KR)

(72) Inventors: Tae-Woo Lee, Hwaseong-Si (KR); Dae-Hwan Kim, Hwaseong-Si (KR)

(21) Appl. No.: 19/252,368

(22) Filed: Jun. 27, 2025

(30) Foreign Application Priority Data
Dec. 16, 2024 (KR) 10-2024-0187263

(51) Int. Cl. H02P 27/06; B60L 15/20; H02P 29/50

(52) U.S. Cl. CPC H02P 27/06; B60L 15/20; H02P 29/50; B60L 2210/40; B60L 2270/14; B60Y 2200/91; B60Y 2306/09

(57) ABSTRACT

An apparatus of a vehicle may comprise a processor and a memory storing at least one instruction. When executed by the processor communicating with the memory, the at least one instruction is configured to cause the apparatus to operate a primary drive inverter of the vehicle to switch a primary drive motor of the vehicle, measure, using a microphone of the vehicle, switching noise caused by the primary drive inverter, determine whether a frequency of the switching noise is above a preset threshold value, and generate, based on the determination, a signal causing connection or disconnection of an auxiliary drive motor of the vehicle to or from a drive shaft of the vehicle.

### CROSS-REFERENCE TO RELATED APPLICATION

This application claims the benefit of priority to Korean Patent Application No. 10-2024-0187263, filed in the Korean Intellectual Property Office on Dec. 16, 2024, the entire contents of which are incorporated herein by reference.

### TECHNICAL FIELD

The present disclosure relates to a system and a method for reducing switching noise caused by an inverter.

### BACKGROUND

The matters described in this Background section are only for enhancement of understanding of the background of the disclosure, and should not be taken as acknowledgment that they correspond to prior art already known to those skilled in the art.

A high-performance vehicle may use a high-output motor and inverter for higher output, unlike other vehicles.

A commercial vehicle (CV)may be equipped with a 160 kW power electronics (PE) drive unit, whereas a CV Gran Turismo (GT) may be equipped with a 270 kW PE drive unit. Therefore, when maximum output is required, the CV GT vehicle may control its motor and inverter at much higher output values compared to the other CV. The high-output motor vehicle may use a Silicon (Si)-based power device (e.g., semiconductor devices, such as power transistors, Metal-Oxide-Semiconductor Field-Effect Transistors (MOSFETs), and Insulated-Gate Bipolar Transistors (IGBTs), etc.) to achieve maximum output, which is disadvantageous in terms of switching noise.

Eco mode is a mode that prioritizes fuel efficiency above all else. Therefore, only a rear-wheel motor may be used to drive the vehicle to avoid fuel efficiency degradation caused by front-wheel drag.

However, in this case, when an Accelerator Pedal Sensor (APS) is pressed to Wide Open Throttle (WOT) (e.g., accelerator pedal is fully pressed, demanding maximum power from a vehicle's motor), the maximum output of the rear-wheel motor may be used. In this case, the full 270 kW power of the rear-wheel motor may be used. In this range, as mentioned above, not only a Silicon Carbide (Sic) based device (e.g., SiC MOSFETs (e.g., EV inverters, DC-DC converters, onboard chargers), SiC Schottky diodes (e.g., power supplies, solar inverters, fast-charging stations), SiC power modules (e.g., industrial motor drives, rail traction, renewable energy systems), SiC JFETs (e.g., high-voltage switching, power grids), and SiC BJTs (e.g., extreme high-power applications, rugged environments), etc.) but also the Si-based device may be used, and thus noise may be generated.

As such, in a high-torque range, a switching frequency may be applied. However, if the switching frequency enters an audible frequency range of human hearing (e.g., about 20 Hz to 20 kHz), it may generate noise, potentially causing significant discomfort for occupants of a vehicle. Increasing the switching frequency beyond the audible frequency may make the noise inaudible, but may adversely affect control efficiency, potentially raising an inverter module's temperature and causing damage to the inverter. To mitigate such risk, Eco mode may be activated to reduce maximum torque and decrease or limit the operational range where only a rear-wheel inverter is used, thereby preventing operation within the noise-generating frequency range.

However, in this case, the total power value in Eco mode may decrease, which may adversely affect power performance.

### SUMMARY

An objective of the present disclosure is to provide a system and a method, which may reduce inverter switching noise by using an electric vehicle disconnector system and torque distribution ratio.

According to the present disclosure, an apparatus of a vehicle the apparatus may comprise a processor, and a memory storing at least one instruction that, when executed by the processor communicating with the memory, is configured to cause the apparatus to operate a primary drive inverter of the vehicle to switch a primary drive motor of the vehicle, measure, using a microphone of the vehicle, switching noise caused by the primary drive inverter, determine whether a frequency of the switching noise is above a preset threshold value, and generate, based on the determination, a signal causing connection or disconnection of an auxiliary drive motor of the vehicle to or from a drive shaft of the vehicle.

The at least one instruction, when executed by the processor, is configured to cause the apparatus to determine that the frequency of the switching noise is above the preset threshold value, and connect, based on the determination that the frequency of the switching noise is above the preset threshold value, the auxiliary drive motor to the drive shaft.

The at least one instruction, when executed by the processor, is configured to cause the apparatus to determine, based on a driving mode of the vehicle being a mode in which the auxiliary drive motor is configured to be inactive, the frequency of the switching noise.

The at least one instruction, when executed by the processor, is configured to cause the apparatus to adjust torque distribution between the primary drive motor and the auxiliary drive motor, such that a total amount of torque distributed between the primary drive motor and the auxiliary drive motor remains unchanged.

The at least one instruction, when executed by the processor, is configured to cause the apparatus to after the adjustment of the torque distribution, determine a second measured frequency of the switching noise, and based on a determination that the second measured frequency of the switching noise is above the preset threshold value, readjust the torque distribution to increase a proportion of torque distributed to the auxiliary drive motor.

The at least one instruction, when executed by the processor, is configured to cause the apparatus to readjust the torque distribution such that a proportion of total torque distributed to the auxiliary drive motor is increased by 10 to 15%, wherein the primary drive motor is associated with rear wheels of the vehicle, and wherein the auxiliary drive motor is associated with front wheels of the vehicle.

According to the present disclosure, a method performed by an apparatus of a vehicle, the method may comprise operating a primary drive inverter of the vehicle associated with a primary drive motor of the vehicle, measuring, using a microphone of the vehicle, switching noise caused by the primary drive inverter of the vehicle, determining whether a frequency of the switching noise is above a preset threshold value, and generating, based on the determining, a signal causing connection or disconnection of an auxiliary drive motor of the vehicle to or from a drive shaft of the vehicle.

The measuring the switching noise may comprise determining whether a driving mode of the vehicle is a mode, in which the auxiliary drive motor of the vehicle is configured to be inactive.

The generating the signal may comprise generating a signal causing adjustment of torque distribution between the primary drive motor and the auxiliary drive motor, such that a total amount of torque distributed between the primary drive motor and the auxiliary drive motor remains unchanged.

The method may further comprise after the adjustment of torque distribution, determining whether a second measured frequency of the switching noise is above the preset threshold value, and based on a determination that the second measured frequency of the switching noise is above the preset threshold value, readjusting the torque distribution to increase a proportion of torque distributed to the auxiliary drive motor.

The readjusting the distribution of torque may comprise readjusting the torque distribution such that a proportion of total torque distributed to the auxiliary drive motor is increased by 10 to 15%.

The method may further comprise connecting, based on a determination that the frequency of the switching noise is above the preset threshold value, the auxiliary drive motor to the drive shaft.

According to the present disclosure, an apparatus of a vehicle, the apparatus may comprise a processor, and a memory storing at least one instruction that is configured, when executed by the processor communicating with the memory, to cause the apparatus to obtain data indicative of switching noise caused by a primary drive inverter of the vehicle, wherein the primary drive inverter is configured to control a primary drive motor of the vehicle, generate, based on a determination that a frequency of the switching noise is within a human-audible frequency range, a signal causing activation of an auxiliary drive motor of the vehicle, and adjust proportions of torque distributed between the primary drive motor and the auxiliary drive motor to shift the frequency of the switching noise outside the human-audible frequency range.

The at least one instruction, when executed by the processor, is configured to cause the apparatus to after the adjustment of the proportions of torque, determine that a second measured frequency of the switching noise is within the human-audible frequency range, and based on the determination that the second measured frequency of the switching noise is within the human-audible frequency range, readjust the proportions of torque to increase a proportion of torque distributed to the auxiliary drive motor.

The at least one instruction, when executed by the processor, is configured to cause the apparatus to increase the proportion of torque distributed to the auxiliary drive motor by a predefined increment. The predefined increment is within a range of 10 to 15%.

The at least one instruction, when executed by the processor, is configured to cause the apparatus to obtain, based on at least one noise measurement associated with a microphone of the vehicle, the data indicative of switching noise, wherein the switching noise corresponds to an audio signal generated by the primary drive inverter.

The at least one instruction, when executed by the processor, is configured to cause the apparatus to measure the frequency of the switching noise by measuring the audio signal to determine a frequency of the audio signal exceeding a predefined threshold.

The at least one instruction, when executed by the processor, is configured to cause the apparatus to activate, based on the signal, the auxiliary drive motor by connecting the auxiliary drive motor to a drive shaft of the vehicle.

The activation of the auxiliary drive motor is a temporary activation of the auxiliary drive motor while the vehicle is operating in a mode in which the auxiliary drive motor is configured to be inactive, and wherein the at least one instruction, when executed by the processor, is configured to cause the apparatus to after the temporary activation of the auxiliary drive motor, generate, based on a second measured frequency of the switching noise being outside the human-audible frequency range, a signal causing deactivation of the auxiliary drive motor of the vehicle.

### BRIEF DESCRIPTION OF THE DRAWINGS

FIG. 1 shows an example of switching noise from an inverter.

FIG. 2 shows an example of noise measured when the present disclosure is applied.

FIG. 3 shows an example of a four-wheel-drive electric vehicle to which the present disclosure is applied.

FIG. 4 and FIG. 5 show examples of a system and a control process for reducing inverter switching noise of the present disclosure.

FIG. 6 shows an example of the torque distribution state.

FIG. 7 shows an example of a method for reducing inverter switching noise of the present disclosure.

### DETAILED DESCRIPTION

In order to fully understand the present disclosure, operational advantages of the same, and the objectives achieved by the implementation of the present disclosure, reference should be made to the accompanying drawings that illustrate preferred examples of the present disclosure and the contents described in the accompanying drawings.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

In the present disclosure, the “system” may include at least one device among a computing device, a network device, a controller, a vehicle device, a server device, and/or a cloud device, but is not limited thereto. For example, the system may include (or configured with) one or more server devices. As another example, the system may include (or configured with) one or more cloud devices. As another example, the system may operate by a server device and a cloud device.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In describing preferred examples of the present disclosure, a known art or repetitive description that may unnecessarily obscure the gist of the present disclosure will be shortened or omitted.

According to the present disclosure, electric vehicle (EV) performance is enhanced by addressing inverter switching noise. High-performance EVs may use powerful motors and inverters, which may generate unpleasant switching noise at certain frequencies, especially in Eco mode where only the rear motor operates at high torque. The proposed system may detect such noise using an in-vehicle microphone and dynamically engage a disconnector to redistribute torque between the front and rear motors, mitigating noise while maintaining efficiency.

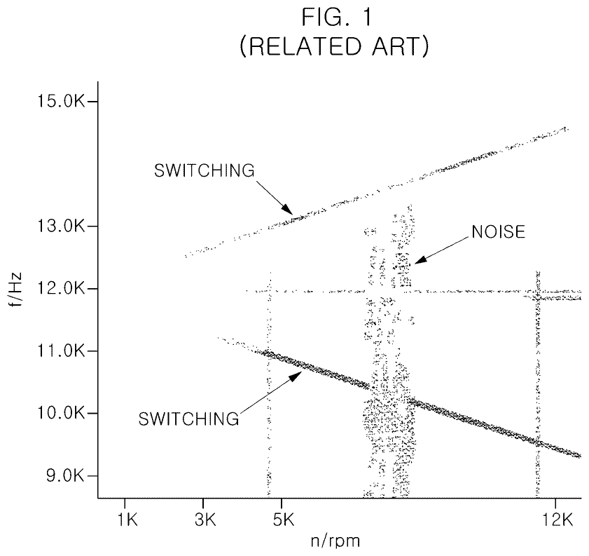

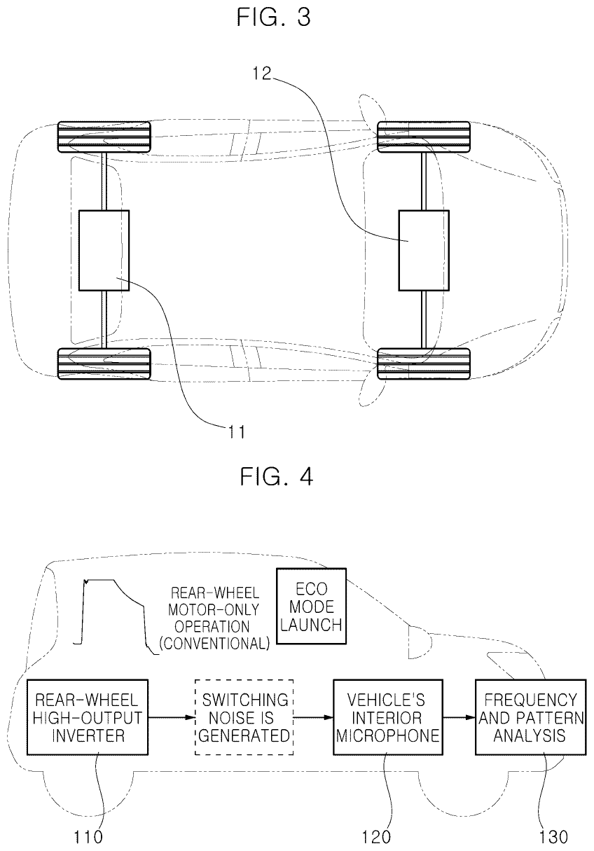

FIG. 1 shows an example of switching noise from an inverter, which occurs due to the switching operations of power semiconductor devices (e.g., Si-based inverters, SiC-based inverters, or GaN-based inverters, etc.) at certain frequency ranges. FIG. 3 shows an example of a four-wheel-drive electric vehicle to which the present disclosure is applied. For example, a four-wheel-drive electric vehicle is primarily driven by a rear-wheel motor 11, while a front-wheel motor 12 remains disengaged in certain driving mode (e.g., Eco mode, coasting mode, or regenerative braking mode, etc.) Torque may be selectively distributed to the front wheels or blocked from the front-wheels depending on whether a disconnector (e.g., a four-wheel drive disconnector, an axle disconnect actuator, a front axle actuator, front axle disconnect actuator, an electromagnetic clutch, a mechanical coupling, or an electronically controlled differential, etc.) is engaged with the front-wheel motor 12.

In certain driving conditions, such as Eco mode, inverter switching noise is generated, as shown in FIG. 1. This noise may be perceived by passengers as a high-pitched whine, a buzzing sound, or an intermittent electronic hum, etc., for example, particularly at low vehicle speeds or high torque demand situations.

A method for reducing switching noise from a high-output inverter (e.g., an Si-based power inverter, a SiC-based power inverter, or a multi-level inverter, etc.) in Eco mode, which may cause discomfort, is as follows:

First, a switching frequency range may be increased. However, the increase in frequency may reduce the efficiency of the inverter, resulting in increased heat generation, higher energy losses, or potential thermal stress on power electronics components (e.g., MOSFETs, IGBTs, or gate drivers, etc.), which may adversely affect the continuous output capability or the inverter's durability.

In addition, avoiding the relevant high-torque range may help mitigate noise, this approach may also result in reduced vehicle performance, including lower acceleration, delayed throttle response, or insufficient torque delivery in demanding driving conditions (e.g., steep inclines, rapid overtakes, or heavy load scenarios, etc.).

In GT mode (e.g., sport mode, track mode, or performance mode, etc.), maximum rear-wheel torque may be used, but front-wheel torque may be also used, resulting in a significantly shorter time to enter the noise-inducing frequency range compared to Eco mode. In addition, GT mode prioritizes performance, the noise generated during aggressive acceleration or rapid torque shifts is understandable from driving dynamics and performance-focused design perspective.

In contrast, the present disclosure proposes a method to intelligently manage motor torque distribution to avoid controlling the rear-wheel motor 11 exclusively, by maintaining total torque output thereof at the same level while strategically engaging the disconnector to use the front-wheel motor 12. For example, the present disclosure introduces a smart control system (e.g., a smart torque redistribution system) that is capable of reducing or minimizing fuel efficiency degradation (e.g., optimizing or enhancing powertrain efficiency) on a real road while ensuring that switching noise remains inaudible or at least imperceptible under normal driving conditions (e.g., optimizing or enhancing acoustic comfort) by using the disconnector. When switching noise is generated, the system uses the vehicle's interior microphone (e.g., an active noise control microphone, a cabin sound sensor, or a machine-learning-based sound classifier, etc.) function to analyzes the frequency and pattern of the noise profile within the range of the generated noise. When the noise is identified as switching noise, the system automatically engages the disconnector and distributes the rear-wheel torque to the front-wheels in a manner that reduces or minimizes performance loss while effectively shifting the noise-generating frequency outside the audible range.

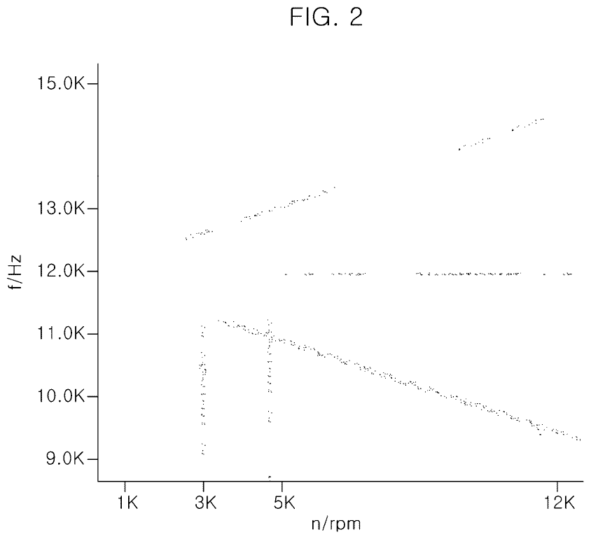

Torque that was previously used only by the rear-wheels is now redistributed to the front-wheels as well, thereby modifying or changing a switching frequency range and potentially shifting the noise outside the audible spectrum (e.g., above 20 kHz for human hearing, into ultrasonic ranges, or into frequency bands less perceivable in a vehicle cabin, etc.). As such, it may be observed in FIG. 2 that when the disconnector is engaged, the switching noise spectrum is altered, and a noise range is effectively minimized or reduced.

In addition, this adjusted torque distribution method targets specific driving conditions, and the torque range is generally not within the operating points range used in regulatory fuel efficiency certification tests (e.g., EPA highway cycles, WLTP testing protocols, or NEDC city drive cycles, etc.). Therefore, even when engaging the disconnector, the system may ensure compliance with regulatory efficiency benchmarks, and the adverse effect on fuel efficiency may be substantially minimized or reduced.

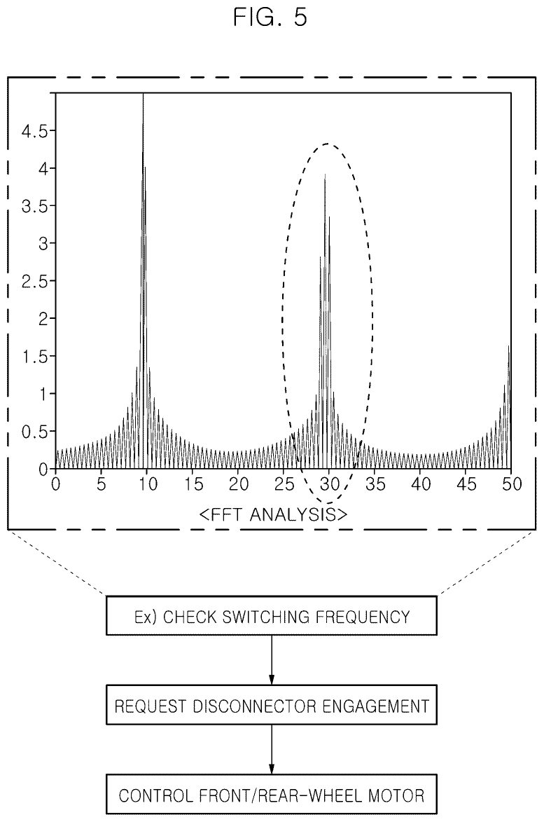

FIGS. 4 and 5 show examples of a system and a control process for reducing inverter switching noise by dynamically altering motor engagement and load distribution strategies in the present disclosure.

The system for reducing inverter switching noise according to an example (e.g., a hardware-based implementation, a software-defined control strategy, or a hybrid approach combining real-time processing with AI-based noise prediction, etc.) of the present disclosure will be described below with reference to FIGS. 4 and 5.

When switching noise is generated due to the rear-wheel inverter 110 (primary drive inverter) (e.g., a silicon-based power inverter, a silicon carbide (SiC) inverter, or a gallium nitride (GaN) inverter, etc.) in a state where only a rear-wheel motor (primary drive motor) is driven under the electric vehicle's ECO mode, the switching noise is detected by an interior microphone 120 (e.g., a standard noise-canceling microphone, an array microphone system, or an AI-enhanced acoustic sensor, etc.) of the vehicle, and a control unit 130 analyzes the frequency domain characteristics, harmonic components, and/or temporal noise patterns of the noise.

As shown in FIG. 5, if a switching frequency at or above a preset frequency threshold value (e.g., 8 kHz, 12 kHz, 15 kHz, or a dynamically adjusted threshold based on real-time analysis, etc.) is confirmed, the control unit 130 generates a command to engage the disconnector (e.g., an electromechanical clutch, a magnetic actuator, or a software-controlled torque transfer device, etc.) to cause the disconnector to be engaged. As the disconnector is engaged, the front-wheel motor 12 (auxiliary drive motor) and the rear-wheel motor 11 are controlled together to enhance torque allocation, noise suppression, and overall system efficiency.

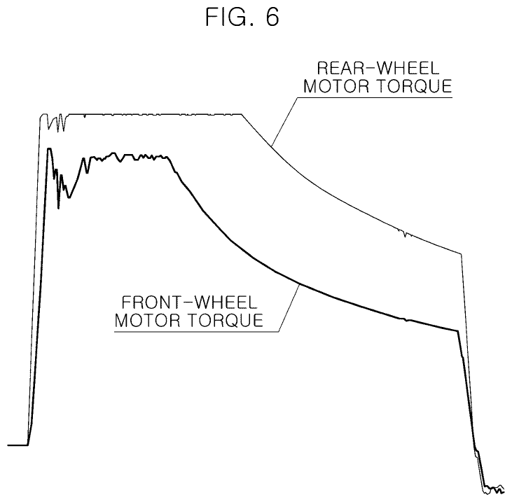

FIG. 6 shows an example of the torque distribution state in response to noise mitigation strategies, where power is dynamically adjusted between the rear-wheel motor and the front-wheel motor (e.g., during high-load acceleration, regenerative braking, or torque vectoring scenarios, etc.).

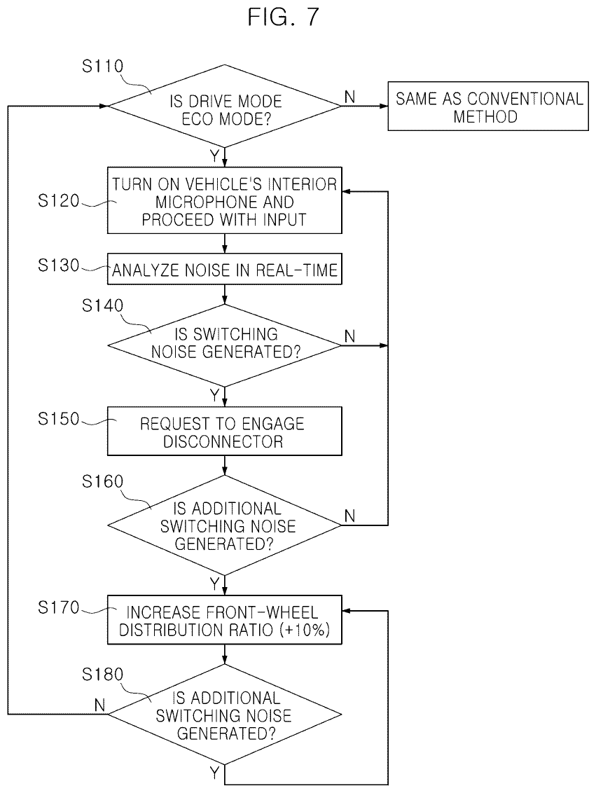

Next, FIG. 7 shows an example of a method for reducing inverter switching noise using a combination of active monitoring, real-time frequency analysis, and dynamic torque redistribution techniques in the present disclosure.

First, a current driving mode is checked (S110). Since the vehicle's control system prioritizes efficiency in Eco mode, rear-wheel motor-only operation may be enabled to reduce drag losses, improve range, and optimize or improve power consumption. The driving mode check ensures that the system only operates in Eco mode before initiating noise suppression processes.

If the driving mode verification confirms that the driving mode is Eco mode (e.g., Eco mode is active), the interior microphone 120 is controlled to turn on (S120) (e.g., activated) and continuously monitored (S120), and the control unit 130 receives and processes noise input (e.g., real-time noise input) from the interior microphone 120 in real time by analyzing frequency domain characteristics, signal amplitude variations, and resonance effects (S130).

The noise analysis step evaluates the spectral composition of the detected signal to determine whether switching noise falls within a problematic range (e.g., 8 kHz, 12 kHz, 15 kHz, or any predefined or dynamically adjusted threshold frequency, etc.) (S140). If the switching noise is detected, a command is issued, for example, by a control circuit, to engage the disconnector (S150) (e.g., an electromagnetic clutch, a mechanical coupling, or a software-controlled electronic differential, etc.), thereby enabling front-wheel torque assistance to minimize, reduce or suppress noise (S150). Accordingly, torque from the rear-wheel inverter 110 is distributed to the front-wheels, which alters the system's switching characteristics, reduces audible noise levels, and improves passenger comfort.

After the front-wheel distribution control (e.g., following the initial torque reallocation), the system continuously monitors whether additional switching noise remains within an audible range (S160). If noise persists, the system adapts by progressively increasing a front-wheel distribution ratio (e.g., by optimizing traction control settings, recalibrating inverter switching patterns, or modifying active power management strategies, etc.), thereby redistributing torque further to the front-wheels and minimizing/reducing additional or residual noise propagated from the rear-wheels (S180).

In this case, the torque redistribution adjustment may increase the front-wheel distribution ratio by 10 to 15% (e.g., based on real-time acoustic feedback, vehicle load conditions, or road surface characteristics, etc.).

The system may perform an additional verification step to determine whether any additional or residual switching noise remains perceptible (S180). If further noise suppression is required, additional corrective actions (e.g., further increasing front-wheel torque, dynamically adjusting switching frequency, or applying active noise cancellation techniques, etc.) may be executed until the desired noise reduction threshold is met.

According to an aspect of the present disclosure, a system for reducing inverter switching noise in an electric vehicle provided with a primary drive motor and an auxiliary drive motor includes: a primary drive inverter configured to switch the primary drive motor; an interior microphone provided within the electric vehicle and configured to measure switching noise caused by the primary drive inverter; and a control unit configured to analyze switching noise input through the interior microphone and determine whether to engage a disconnector configured to connect or disconnect the auxiliary drive motor to or from a drive shaft.

In addition, the control unit analyzes a frequency of the switching noise, and engages the disconnector if a switching frequency at or above a preset threshold value is confirmed.

Here, the control unit analyzes the switching noise when a driving mode of the electric vehicle is Eco mode.

In particular, the control unit distributes torque of the primary drive motor to the auxiliary drive motor without changing total torque.

Furthermore, after engaging the disconnector, the control unit re-analyzes the switching noise, and increases a front-wheel distribution ratio if the switching frequency is confirmed.

Here, after engaging the disconnector, the control unit increases the front-wheel distribution ratio by 10 to 15% if the switching frequency is confirmed.

Next, according to an aspect of the present disclosure, a method for reducing inverter switching noise in an electric vehicle provided with a primary drive motor and an auxiliary drive motor includes: measuring, by an interior microphone provided within the electric vehicle, switching noise caused by the primary drive inverter; analyzing the switching noise input through the interior microphone; and analyzing a frequency of the switching noise, and engaging the disconnector configured to connect or disconnect the auxiliary drive motor to or from a drive shaft if a switching frequency at or above a preset threshold value is confirmed.

In addition, the method further includes checking whether a driving mode of the electric vehicle is Eco mode, wherein if the driving mode is Eco mode, the switching noise is measured.

In particular, in said engaging a disconnector, torque of the primary drive motor is distributed to the auxiliary drive motor without changing total torque.

Furthermore, the method further includes, after said engaging a disconnector, checking whether the switching noise is additionally generated; and if it is confirmed that the switching noise is additionally generated, increasing a front-wheel distribution ratio.

Here, in said increasing a front-wheel distribution ratio, the front-wheel distribution ratio is increased by 10 to 15%.

With the present disclosure, inverter switching noise may be reduced by analyzing the switching noise inside the vehicle, engaging the disconnector, and distributing torque to the front-wheels.

The torque range is generally not within the operating points range used for fuel efficiency certification, and thus the adverse effect on fuel efficiency may also be minimized.

As described above, the present disclosure may reduce inverter switching noise and minimize the adverse effect on fuel efficiency by analyzing the switching noise inside the vehicle, engaging the disconnector, and distributing torque to the front-wheels.

Although the present disclosure has been described with reference to the illustrative drawings, it will be apparent to those skilled in the art that the present disclosure is not limited to the examples described herein and that various modifications and variations are possible without departing from the spirit and scope of the present disclosure. Therefore, such modifications or variations should fall within the scope of the claims of the present disclosure, and the scope of rights of the present disclosure should be construed based on the accompanying claims.

What is claimed:

1. An apparatus of a vehicle the apparatus comprising:
a processor; and
a memory storing at least one instruction that, when executed by the processor communicating with the memory, is configured to cause the apparatus to:
operate a primary drive inverter of the vehicle to switch a primary drive motor of the vehicle;
measure, using a microphone of the vehicle, switching noise caused by the primary drive inverter;
determine whether a frequency of the switching noise is above a preset threshold value; and
generate, based on the determination, a signal causing connection or disconnection of an auxiliary drive motor of the vehicle to or from a drive shaft of the vehicle.

2. The apparatus of claim 1, wherein the at least one instruction, when executed by the processor, is configured to cause the apparatus to:
determine that the frequency of the switching noise is above the preset threshold value, and
connect, based on the determination that the frequency of the switching noise is above the preset threshold value, the auxiliary drive motor to the drive shaft.

3. The apparatus of claim 2, wherein the at least one instruction, when executed by the processor, is configured to cause the apparatus to determine, based on a driving mode of the vehicle being a mode in which the auxiliary drive motor is configured to be inactive, the frequency of the switching noise.

4. The apparatus of claim 2, wherein the at least one instruction, when executed by the processor, is configured to cause the apparatus to adjust torque distribution between the primary drive motor and the auxiliary drive motor, such that a total amount of torque distributed between the primary drive motor and the auxiliary drive motor remains unchanged.

5. The apparatus of claim 4, wherein the at least one instruction, when executed by the processor, is configured to cause the apparatus to:
after the adjustment of the torque distribution, determine a second measured frequency of the switching noise, and
based on a determination that the second measured frequency of the switching noise is above the preset threshold value, readjust the torque distribution to increase a proportion of torque distributed to the auxiliary drive motor.

6. The apparatus of claim 5, wherein the at least one instruction, when executed by the processor, is configured to cause the apparatus to readjust the torque distribution such that a proportion of total torque distributed to the auxiliary drive motor is increased by 10 to 15%,
wherein the primary drive motor is associated with rear wheels of the vehicle, and
wherein the auxiliary drive motor is associated with front wheels of the vehicle

7. A method performed by an apparatus of a vehicle, the method comprising:
operating a primary drive inverter of the vehicle associated with a primary drive motor of the vehicle;
measuring, using a microphone of the vehicle, switching noise caused by the primary drive inverter of the vehicle;
determining whether a frequency of the switching noise is above a preset threshold value; and
generating, based on the determining, a signal causing connection or disconnection of an auxiliary drive motor of the vehicle to or from a drive shaft of the vehicle.

8. The method of claim 7, wherein the measuring the switching noise comprises determining whether a driving mode of the vehicle is a mode, in which the auxiliary drive motor of the vehicle is configured to be inactive.

9. The method of claim 7, wherein the generating the signal comprises generating a signal causing adjustment of torque distribution between the primary drive motor and the auxiliary drive motor, such that a total amount of torque distributed between the primary drive motor and the auxiliary drive motor remains unchanged.

10. The method of claim 9, further comprising:
after the adjustment of torque distribution, determining whether a second measured frequency of the switching noise is above the preset threshold value; and
based on a determination that the second measured frequency of the switching noise is above the preset threshold value, readjusting the torque distribution to increase a proportion of torque distributed to the auxiliary drive motor.

11. The method of claim 10, wherein the readjusting the distribution of torque comprises readjusting the torque distribution such that a proportion of total torque distributed to the auxiliary drive motor is increased by 10 to 15%.

12. The method of claim 7, further comprising:
connecting, based on a determination that the frequency of the switching noise is above the preset threshold value, the auxiliary drive motor to the drive shaft.

13. An apparatus of a vehicle, the apparatus comprising:
a processor; and
a memory storing at least one instruction that is configured, when executed by the processor communicating with the memory, to cause the apparatus to:
obtain data indicative of switching noise caused by a primary drive inverter of the vehicle, wherein the primary drive inverter is configured to control a primary drive motor of the vehicle;
generate, based on a determination that a frequency of the switching noise is within a human-audible frequency range, a signal causing activation of an auxiliary drive motor of the vehicle; and
adjust proportions of torque distributed between the primary drive motor and the auxiliary drive motor to shift the frequency of the switching noise outside the human-audible frequency range.

14. The apparatus of claim 13, wherein the at least one instruction, when executed by the processor, is configured to cause the apparatus to:
after the adjustment of the proportions of torque, determine that a second measured frequency of the switching noise is within the human-audible frequency range; and
based on the determination that the second measured frequency of the switching noise is with the human-audible frequency range, readjust the proportions of torque to increase a proportion of torque distributed to the auxiliary drive motor.

15. The apparatus of claim 13, wherein the at least one instruction, when executed by the processor, is configured to cause the apparatus to:
increase the proportion of torque distributed to the auxiliary drive motor by a predefined increment.

16. The apparatus of claim 15, wherein the predefined increment is within a range of 10 to 15%.

17. The apparatus of claim 13, wherein the at least one instruction, when executed by the processor, is configured to cause the apparatus to:
obtain, based on at least one noise measurement associated with a microphone of the vehicle, the data indicative of switching noise, wherein the switching noise corresponds to an audio signal generated by the primary drive inverter.

18. The apparatus of claim 17, wherein the at least one instruction, when executed by the processor, is configured to cause the apparatus to measure the frequency of the switching noise by:
measuring the audio signal to determine a frequency of the audio signal exceeding a predefined threshold.

19. The apparatus of claim 13, wherein the at least one instruction, when executed by the processor, is configured to cause the apparatus to:
activate, based on the signal, the auxiliary drive motor by connecting the auxiliary drive motor to a drive shaft of the vehicle.

20. The apparatus of claim 13, wherein the activation of the auxiliary drive motor is a temporary activation of the auxiliary drive motor while the vehicle is operating in a mode in which the auxiliary drive motor is configured to be inactive, and
wherein the at least one instruction, when executed by the processor, is configured to cause the apparatus to:
after the temporary activation of the auxiliary drive motor, generate, based on a second measured frequency of the switching noise being outside the human-audible frequency range, a signal causing deactivation of the auxiliary drive motor of the vehicle.
